(19) United States
(12) Patent Application Publication
(10) Pub. No.: US 2014/0184630 A1
(43) Pub. Date: Jul. 3, 2014

(54) OPTIMIZING IMAGE MEMORY ACCESS

(71) Applicant: Scott A. Krig, Folsom, CA (US)

(72) Inventor: Scott A. Krig, Folsom, CA (US)

(21) Appl. No.: 13/727,736

(22) Filed: Dec. 27, 2012

(51) Int. Cl. G06F 12/08

(52) U.S. Cl. CPC G06F 12/0862
USPC 345/557

(57) ABSTRACT

An apparatus and system for accessing an image in a memory storage is disclosed herein. The apparatus includes logic to pre-fetch image data, wherein the image data includes pixel regions. The apparatus also includes logic to arrange the image data as a set of one-dimensional arrays to be linearly processed. The apparatus further includes logic to process a first pixel region from the image data, wherein the first pixel region is stored in a cache. Additionally, the apparatus includes logic to place a second pixel region from the image data into the cache, wherein the second pixel region is to be processed after the first pixel region has been processed, and logic to process the second pixel region. Logic to write the set of one-dimensional arrays back into the memory storage is also provided, and the first pixel region is evicted from the cache.

### TECHNICAL FIELD

The present invention relates generally to accessing memory. More specifically, the present invention relates to the accessing imaging memory using a Stepper Tiler Engine.

### BACKGROUND ART

Computer activities that access images stored in memory may continuously access some portion of the image in the memory. Accordingly, streaming video from a camera or sending images to a high-speed printer can require data bandwidth of several gigabytes per second. Poor management of memory and data bandwidth can lead to poor imaging performance.

Furthermore, various types of inefficiency or errors may occur while accessing images in storage. For example, a processor may attempt to process a line or region of the image that has not been placed in a cache, resulting in the line or image being processed from storage. A cache is a smaller memory that may be accessed faster when compared to storage. When the line or region of the image is processed from storage after not being found in the cache, the result is a cache miss. A cache miss can slow down image memory access when compared to an image that is processed without any cache misses.

### BRIEF DISCUSSION OF THE DRAWINGS

The following detailed description may be better understood by referencing the accompanying drawings, which contain specific examples of numerous objects and features of the disclosed subject matter:

FIG. 1 is a block diagram of a computing device that may be used in accordance with embodiments;

FIG. 2 is a diagram illustrating an arrangement of an image into a one-dimensional array, in accordance with embodiments;

FIG. 3 is an illustration of a rectangle assembler;

FIGS. 4A, 4B, and 4C illustrate an example of linearly processing an image using rectangular buffers, in accordance with embodiments;

FIGS. 5A, 5B, and 5C illustrate an example of linearly processing an image using line buffers, in accordance with embodiments;

FIG. 6 is a process flow diagram of a method to access an image stored in memory, in accordance with embodiments; and

FIG. 7 is a diagram of computer-readable media containing instructions to access an image stored in memory, in accordance with embodiments.

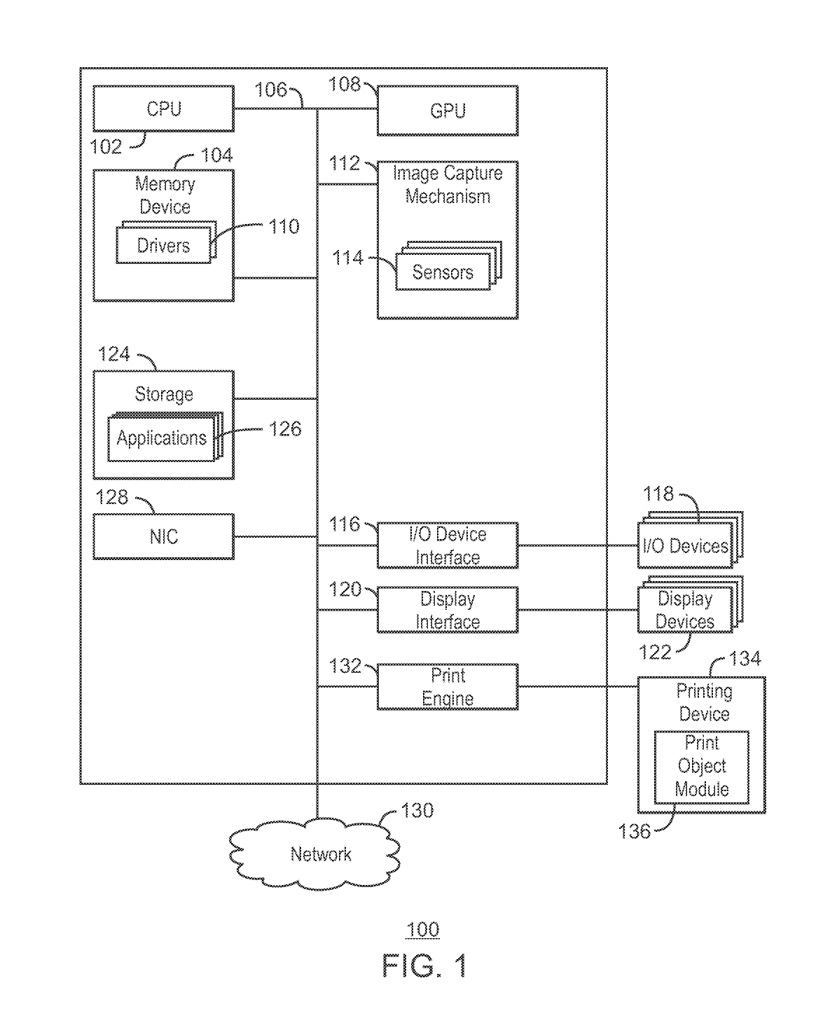

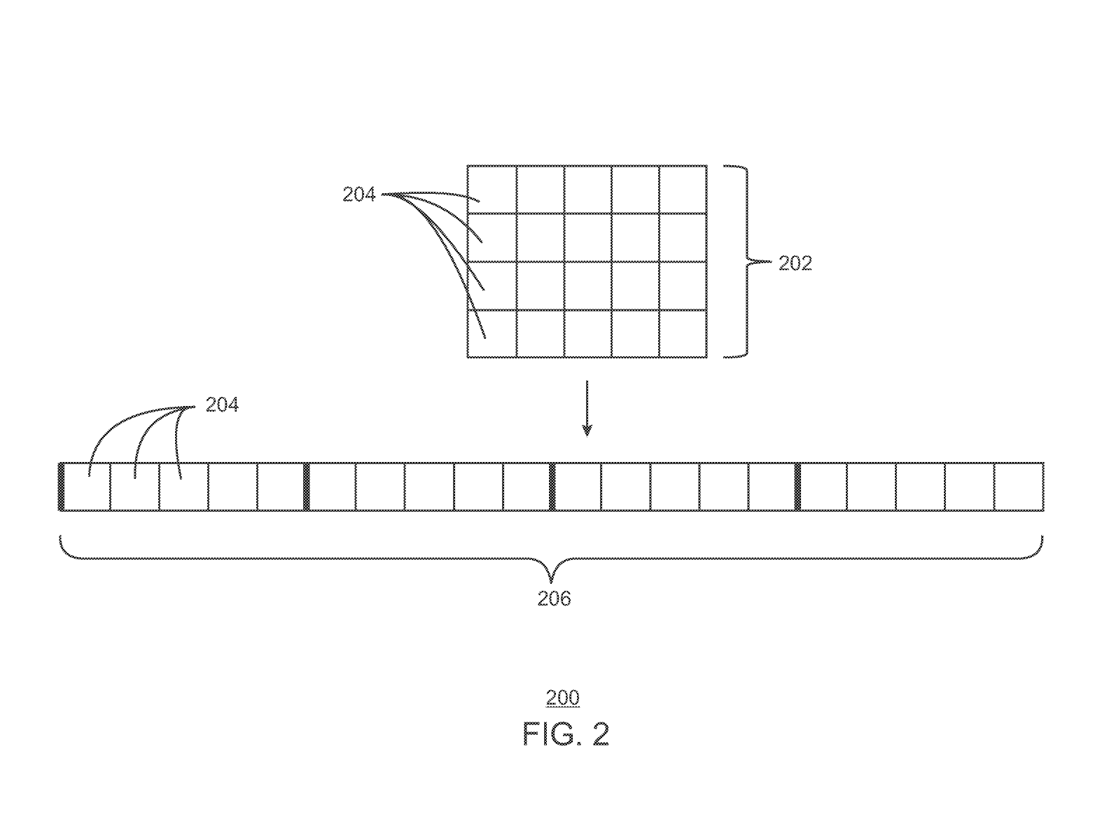

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Embodiments described herein disclose optimizing image memory access. An image is arranged as a one-dimensional (1D) array such that a linear access pattern can be enabled. An image, as used herein, may be a two-dimensional bit map, a frame of a video, or a three-dimensional object. Image data can be composed of pixel regions. The term pixel region, as used herein, can be at least one of a single pixel, a group of pixels, a region of pixels, or any combination thereof. The image can be processed as pixel regions or groups of lines or rectangular regions. In embodiments, the term increment may also be referred to herein interchangeably with the terms line, line buffer, rectangle, rectangular buffer, data buffer, array, 1D array, or buffer. Processing, as used herein, can refer to copying, transferring, or streaming increments or pixel regions of the image from memory to a processor or output of an electronic device, such as a computer, printer, or camera. Thus, instead of inefficient memory access to non-linear rectangular memory regions or non-contiguous lines, the desired rectangular or line access patterns of data are packed sequentially into a set of 1D arrays for ease of memory access and ease of computation. One skilled in the art will recognize that this method of packing memory patterns into 1D arrays allows for standard vector processing instructions and auto-increment memory access instructions to be employed to access and process the data efficiently.

The Stepper Tiler Engine acts as a pipelined machine to pre-fetch memory patterns for the rectangle assembler. The rectangle assembler assembles the memory patterns into a set of linear packed 1D arrays in a cache. The Stepper Tiler Engine may then make the set of 1D arrays available to processors. Processing units may then access the 1D arrays using pointers. The processing units process the data, then the Stepper Tiler Engine writes the processed data from the 1D arrays back to the cache or a storage. The rectangle assembler may evict the 1D arrays from the cache after the processing is complete.

Additionally, the Stepper Tiler Engine includes a set of status and control registers which may be programmed to automatically access the memory patterns and assemble them into linear packed 1D arrays as discussed above. The memory patterns may be accessed in a pipelined manner, where each pattern is accessed sequentially. The Stepper Tiler Engine includes programmable capabilities to sequentially step over the entire image region to be processed, and assemble memory patterns such as rectangles and lines into packed linear 1D arrays as a pre-fetch step in the pipeline. The memory patterns may also be accessed in an overlapping manner, which also enables pre-fetch and processing. When the memory patterns are pre-fetched, the memory is accessed by the Stepper Tiler Engine and assembled into 1D arrays in the cache while a processor is accessing the 1D arrays from cache. As discussed above, already processed or used 1D arrays may be evicted from the cache after they have been written back to the appropriate location in memory by the Stepper Tiler Engine.

Additionally, in embodiments, a line or region of the image may be placed into a cache before the line or region is processed to prevent cache misses. Because the image is arranged as a one-dimensional array and the access pattern is linear, processing the array of data can be faster using memory addressing auto-increment instructions and array processing oriented instruction sets, since the next line or region to be processed during image memory access can be predicted. The line or region can be prepared by storing in the cache for quick access and processing. Using the methods disclosed herein to pack memory patterns such as rectangles or selected lines into a set of linear 1D arrays, embodiments described herein can provide for optimizations for memory access to speed up processing, as the processors would otherwise need to wait for memory read and write operations to complete before continuing with processing.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a computing device 100 that may be used in accordance with embodiments. The computing device 100 may be, for example, a laptop computer, desktop computer, tablet computer, mobile device, or server, among others. The computing device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the computing device 100 may include more than one CPU 102. The instructions that are executed by the CPU 102 may be used to optimize memory access. Many computing architectures besides a CPU may be used in an embodiment of this invention, such as a single instruction multiple data (SIMD) instruction set, a digital signal processing (DSP) processor, an image signal processor (ISP) processor, a GPU, or other type of array processors such as a very large instruction word (VLIW) machine.

The computing device 100 may also include a graphics processing unit (GPU) 108. As shown, the CPU 102 may be coupled through the bus 106 to the GPU 108. The GPU 108 may be configured to perform any number of graphics operations within the computing device 100. For example, the GPU 108 may be configured to render or manipulate graphics images, graphics frames, videos, or the like, to be displayed to a user of the computing device 100. In some embodiments, the GPU 108 includes a number of graphics engines (not shown), wherein each graphics engine is configured to perform specific graphics tasks, or to execute specific types of workloads.

The memory device 104 can include random access memory (RAM), read only memory (ROM), flash memory, or any other suitable memory systems. For example, the memory device 104 may include dynamic random access memory (DRAM). The memory device 104 may include a device driver 110 that is configured to execute the instructions for optimizing image memory access. The device driver 110 may be software, an application program, application code, or the like.

The computing device 100 includes an image capture mechanism 112. In embodiments, the image capture mechanism 112 is a camera, stereoscopic camera, infrared sensor, or the like. The image capture mechanism 112 is used to capture image information. Accordingly, the computing device 100 also includes one or more sensors 114. In examples, a sensor 114 may also be an image sensor used to capture image texture information. Furthermore, the image sensor may be a charge-coupled device (CCD) image sensor, a complementary metal-oxide-semiconductor (CMOS) image sensor, a system on chip (SOC) image sensor, an image sensor with photosensitive thin film transistors, or any combination thereof. The device driver 110 may access the image captured by the sensor 114 using a Stepper Tiler Engine.

The CPU 102 may be connected through the bus 106 to an input/output (I/O) device interface 116 configured to connect the computing device 100 to one or more I/O devices 118. The I/O devices 118 may include, for example, a keyboard and a pointing device, wherein the pointing device may include a touchpad or a touchscreen, among others. The I/O devices 118 may be built-in components of the computing device 100, or may be devices that are externally connected to the computing device 100.

The CPU 102 may also be linked through the bus 106 to a display interface 120 configured to connect the computing device 100 to a display device 122. The display device 122 may include a display screen that is a built-in component of the computing device 100. The display device 122 may also include a computer monitor, television, or projector, among others, that is externally connected to the computing device 100.

The computing device also includes a storage device 124. The storage device 124 is a physical memory such as a hard drive, an optical drive, a thumbdrive, an array of drives, or any combinations thereof. The storage device 124 may also include remote storage drives. The storage device 124 includes any number of applications 126 that are configured to run on the computing device 100. The applications 126 may be used to process image data. In examples, an application 126 may be used optimize image memory access. Further, in examples, an application 126 may access images in memory in order to perform various processes on the images. The images in memory may be accessed using the Stepper Tiler Engine described below.

The computing device 100 may also include a network interface controller (NIC) 128 may be configured to connect the computing device 100 through the bus 106 to a network 130. The network 130 may be a wide area network (WAN), local area network (LAN), or the Internet, among others.

In some embodiments, an application 126 can send an image from the computing device 100 to a print engine 132. The print engine may send the image to a printing device 134. The printing device 134 can include printers, fax machines, and other printing devices that can print various images using a print object module 136. In embodiments, the print engine 132 may send data to the printing device 134 across the network 130. In addition, devices such as the image capture mechanism 112 may use the techniques described herein to process arrays of pixels. Display devices 122 may also use the techniques described herein in embodiments to accelerate the processing of pixels on a display.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

FIG. 2 is a diagram illustrating an arrangement scheme 200 of an image into a one-dimensional array, in accordance with embodiments. The arrangement scheme 200 can be performed by a Stepper Tiler Engine and a Rectangle Assembler logic prior to accessing the image in memory to improve the efficiency of processes that access the image in memory. The Stepper Tiler engine can provide memory buffering, in which regions of a two-dimensional image 202 are rapidly processed in a procedural manner. The Stepper Tiler can use a Stepper Cache to store selected regions of the two-dimensional image during imaging access. It is to be noted that in the embodiments disclosed herein, any cache capable of quick access can be used.

The two-dimensional image 202 in a memory 104 (FIG. 1)can be divided into a number of pixel regions 204. Each pixel region 204 can contain one or more pixels. In embodiments, each pixel region 204 can represent a rectangular grouping of pixels, or a line of pixels, or a region composed of lines and rectangles together. During image memory access, each pixel region 204 may be placed into a cache where the pixel region 204 is to be processed by the CPU 102, and subsequently removed from the cache 110 after processing. In addition to a CPU, embodiments may use any other processing architecture or method including but not limited to a logical block, single instruction multiple data (SIMD), GPU, digital signal processor (DSP), image signal processor (ISP) or very large instruction word (VLIW) machine.

The Stepper Tiler engine can reconfigure the two-dimensional image 202 as a set of one-dimensional arrays 206 of regions, such as lines and rectangles. Thus, any access pattern can be packed into a linear 1D array for ease of memory access and ease of computation as opposed to non-linear memory regions. Each block of the one-dimensional array 206 can represent an pixel region 204, which can be a rectangular grouping or line of pixels. While the process of assembling the two-dimensional image 202 into the set of one-dimensional arrays 206 is shown in FIG. 2 by converting each rectangular block of the two-dimensional image 202 into a pixel region 204 of the one-dimensional array 206, any type of access pattern may be used. For example, each column of the two-dimensional image 204 may also be assembled into a 1D array.

This configuration by the Stepper Tiler allows the CPU 102 to process each pixel region 204 in a linear sequential pattern as opposed to an irregular pattern for a two-dimensional array. Irregular memory access patterns can cause delays in processing, since the access patterns cannot be read or written in predictable manner. Furthermore, a memory system may consist of various sizes and levels of cache, wherein the cache closer to the processor has a faster access time when compared to other memory, which is farther away from the processor. By optimizing the memory access into linear 1D arrays, the memory performance can be optimized and pipelined with the processing stages. In embodiments, the pixel regions 204 can be read from left to right, or right to left. As one pixel region 204 is being processed, the next pixel region in the sequence can be transferred from the memory storage 104 to the cache, while another pixel region that has been processed previously can be removed from the cache.

Through the Stepper Tiler Engine, auto-increment instructions can be used to rapidly access each pixel region 204 of the one-dimensional array 206. For example, a fast fused memory auto-increment instruction such as *data++, typically used in C++, can access any portion of the image data without using a specific memory access pattern. The auto-increment instructions can access data using a base address and an offset, which typically requires one calculation to find the address of the target data in the array. Thus, the auto-increment instructions enable faster memory access when compared to addressing modes used to access data in arrays. For example, using C++, a 2D array would be accessed using an instruction such as data [x][y], where x represents the row and y represents the column of the target data. However, such an instruction typically requires several calculations before the address of the target data is obtained. Accordingly, the arrangement of data into a sequential 1D array enables faster data access when compared to 2D arrays.

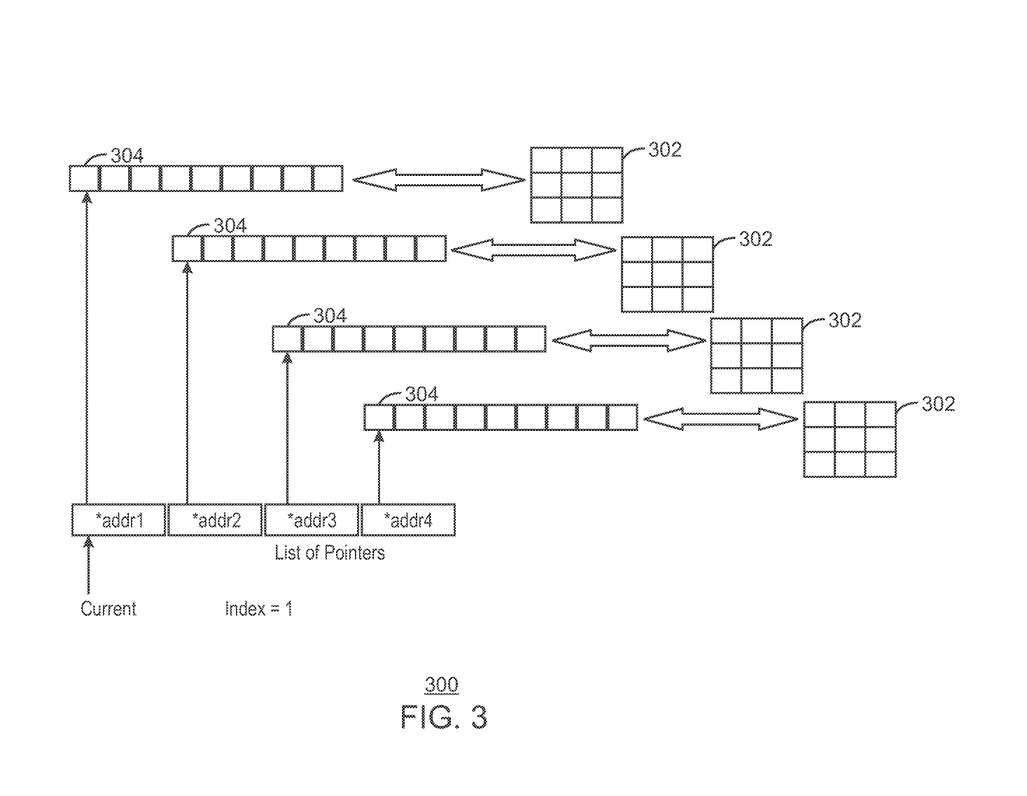

FIG. 3 is a diagram illustrating a rectangle assembler 300, in accordance with embodiments. The rectangle assembler 300 can be an engine, a command, or logic in the Stepper Tiler that can be used to prepare two-dimensional images for memory buffering. The rectangle assembler 300 can operate on two-dimensional arrays 302 to assemble them as one-dimensional arrays 304 or area vectors. Each of the two-dimensional arrays 302 contains pixel regions which, in some embodiments, can represent pixels or groupings of pixels of a two-dimensional image. Each block in a two-dimensional array 302 may be given a designation corresponding to the pixel region's X and Y coordinates within the two-dimensional array 302. As discussed above, the instruction in C++ to access a pixel region would be “data [x][y]”.

The rectangle assembler 300 can assemble each two-dimensional array 302 as a one-dimensional array 304 such that the blocks contained within each array are arranged in a sequential order, allowing for a faster, more predictable access pattern. As discussed above, a CPU can access each block in sequence with an auto-increment machine instruction form, which can perform both processing and memory incrementing in the same fused instruction, which is more efficient than issuing a first instruction to change or increment the memory address, and a second instruction to perform the processing. For example, the instruction in C++ software to access the sequence of blocks can contain the instruction “*data++”, which would allow code to be generated to use auto-increment instruction forms to instruct the CPU to access each succeeding block after processing the current block. By formatting the rectangles of line access patterns into packed linear 1D arrays, the Stepper Tiler Engine provides for efficient fused processing and memory auto-increment instructions as well as increasing speed to access memory, as the 1D arrays can be a size that enables the 1D arrays to be kept close to the processors in the cache.

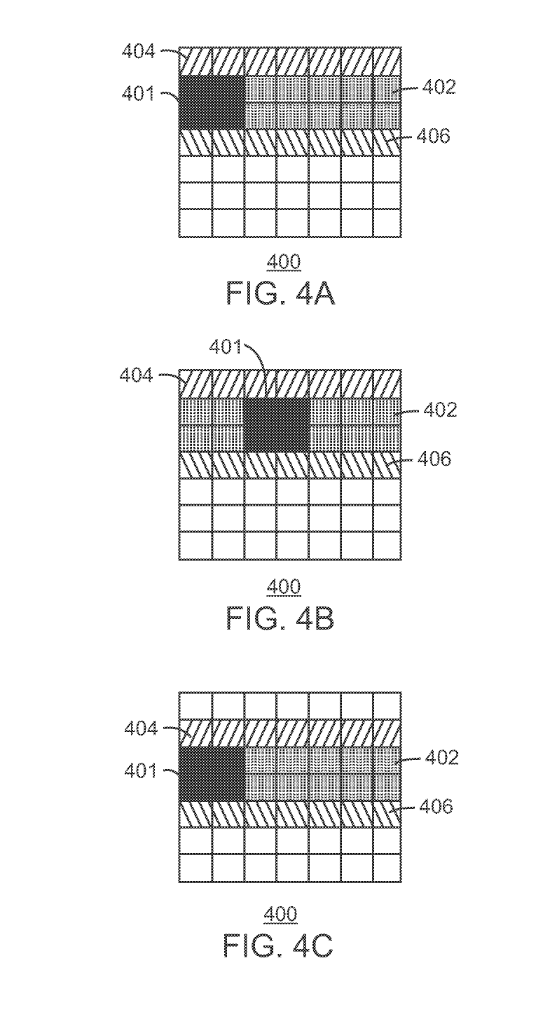

FIGS. 4A, 4B, and 4C illustrate an example of linearly processing an image using rectangular buffers, in accordance with embodiments. FIGS. 4A, 4B and 4C illustrate using the Stepper Tiler Engine with a rectangular region to be processed that can be moved across a set of line buffers and contained in the Stepper Tiler fast cache. The Stepper Tiler Engine can pre-fetch the lines before they are needed to allow for the Rectangle Assembler to pre-assemble the rectangular regions as a set of packed linear 1D arrays in a pipelined manner for processing. The lines can be pre-fetched and stored in fast Stepper Tiler cache as containers for extracting the rectangles. In the figures, pixel regions or regions of increments in the image 400 can be sectioned off and designated as a processing region 401, an active buffer 402, an eviction buffer 404, and a pre-fetch buffer 406. The size and shape of each of the regions or buffers can be defined prior to processing.

The processing region 401 can represent a region from the image 400 that is currently being processed. The image can be streamed to a printer, video device, or display interface for viewing or imaging enhancements. In embodiments, the processing region 401 is a rectangular area being streamed from the cache 110 to the output device 106 by the CPU 102. For descriptive purposes, the processing region 401 is shown as a black box. The active buffer 402 can represent a set of one or more lines that are stored in the cache 110. For descriptive purposes, the active buffer is shown as using dots within the blocks of the active buffer 402. In FIGS. 4A, 4B, and 4C, the active buffer 402 in this illustrative embodiment is defined as containing two lines of seven pixel regions each. It is to be noted that in some embodiments, the active 402 can contain a different number of pixel regions. As shown in FIGS. 4A and 4B, the processing region 401 moves incrementally along the active buffer 402 as each grouping of pixels or increments is processed in a sequential order. When all pixels in the active buffer 402 have been processed, the next set of lines in a sequence is placed into the active buffer 402, as shown in FIG. 4C.

The eviction buffer 404 can represent one or more lines that have been previously processed as part of the active buffer 402. In FIGS. 4A, 4B, and 4C, the eviction buffer 404 can is defined in this illustrative embodiment example as containing a single line of seven pixel regions. It is to be noted that in some embodiments, the eviction buffer 404 can contain a different number of pixel regions. As the lines are no longer needed, the lines in the eviction buffer 404 are removed from the cache as the current active buffer 402 is processed.

The pre-fetch buffer 406 can represent one or more lines that are next in the sequence to be processed as part of the active buffer 402. In FIGS. 4A, 4B, and 4C, the pre-fetch buffer 406 is defined as containing a single line of seven pixel regions. While the active buffer 402 is processed, lines in the pre-fetch buffer 404 can be placed in the cache 110 such that the lines can be processed immediately after the lines in the active buffer 402 have finished being processed.

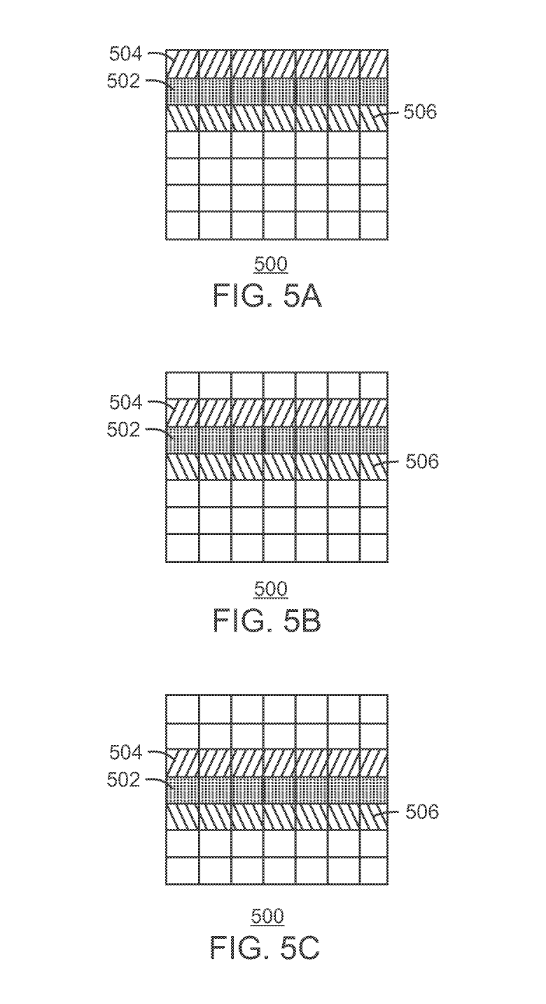

FIGS. 5A, 5B, and 5C illustrate an example of linearly processing an image using line buffers, in accordance with embodiments. In the figures, pixel regions in the image 500 can be sectioned off and designated as an active buffer 402, an eviction buffer 404, and a pre-fetch buffer 506.

The active buffer 502 can represent a set of one or more lines that are stored in the cache 110. In FIGS. 5A, 5B, and 5C, the active buffer 502 is defined as containing a single of seven pixel regions. It is to be noted that in some embodiments, the active buffer 502 can contain a different number of pixel regions. As shown in FIGS. 5A, 5B, and 5C, the active buffer 502 moves from line to line in sequential order as each line is processed.

The eviction buffer 504 can represent one or more lines that have been previously processed as part of the active buffer 502. In FIGS. 5A, 5B, and 5C, the eviction buffer 404 can is defined as containing a single line of seven pixel regions. As the lines are no longer needed, the lines in the eviction buffer 504 are removed from the cache as the current active buffer 502 is processed.

The pre-fetch buffer 506 can represent one or more lines that are next in the sequence to be processed as part of the active buffer 502. In FIGS. 5A, 5B, and 5C, the pre-fetch buffer 506 is defined as containing a single line of seven pixel regions. While the active buffer 502 is processed, lines in the pre-fetch buffer 504 can be placed in the cache 110 such that the lines can be processed immediately after the lines the active buffer 502 have finished being processed.

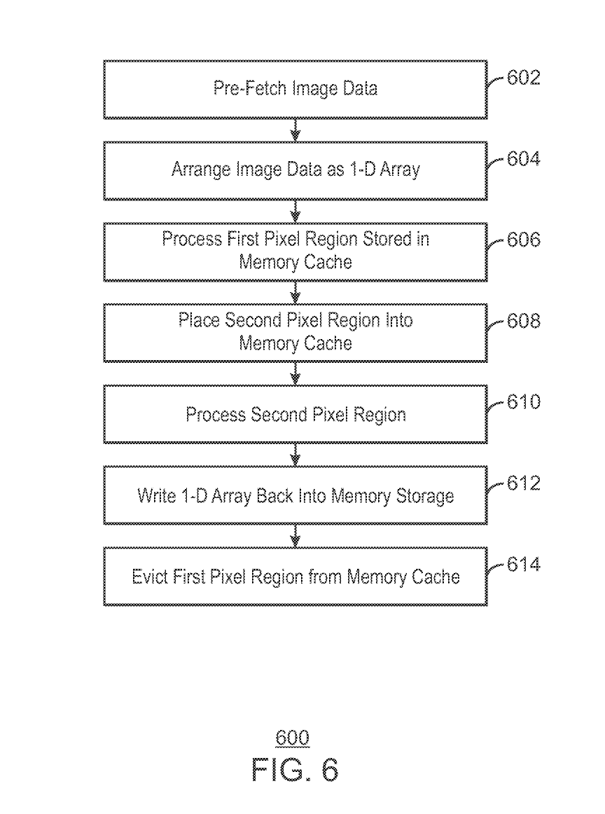

FIG. 6 is a process flow diagram of a method 600 to access an image stored in memory. The method 600 can be performed by a Stepper Tiler Engine of a CPU in an electronic device such as a computer or a camera. The method 500 may be implemented with computer code written in C, C++, MATLAB, FORTRAN, or Java.

At block 602, the Stepper Tiler Engine pre-fetches image data from the memory storage. The image data may be composed of pixel regions, wherein pixel regions can be at least one of a pixel, a grouping of pixels, a region of pixels, or any combination thereof.

At block 604, the Stepper Tiler Engine arranges the image data as a one-dimensional array to be linearly processed. The one-dimensional array can be accessed as a linear sequence of pixel regions. The properties and size of each pixel region can be determined in the written code. The written code can also contain the addresses of the image's storage location and destination. Although 2D image processing is described, the present techniques may be used for any image processing, such as 2D image processing, 3D image processing, or n-D image processing.

In embodiments, the rectangle assembler may cache data as an array of pointers instead of copying the data again into a 1D array. In this manner, the rectangles are assembled into 1D arrays of pointers to the lines in the cache which contain the rectangles. As a result, the pre-fetched lines are copied into the Stepper Tiler cache once, which prevents multiple copies. In this type of 1D array embodiment, the 1D arrays are represented as an array of pointers to the rectangular regions in the line buffers. Correspondingly, the same arrangement is can be used to write data back to memory prior to cache eviction.

At block 606, the Stepper Tiler Engine processes a first pixel region stored in a cache. For example, processing a first pixel may include streaming or transferring an pixel region to an input/output device such as a computer monitor, printer, or camera.

At block 608, the Stepper Tiler Engine places a second pixel region from the image into the cache. The processor can transfer, or pre-fetch, one or more pixel regions into the cache. The number of pixel regions to be pre-fetched into the cache can be determined in the written code. The second pixel region is to be processed after the first pixel region has been processed.

At block 610, the Stepper Tiler Engine processes the second pixel region. The processor can process the pixel regions placed into the cache, and stream the pixels contained to the input/output device. The pixel regions can be processed all at once, or by one pixel at a time.

At block 612, the Stepper Tiler engine writes the one-dimensional array back into the memory storage. The one-dimensional array can be written back as a two-dimensional image.

At block 614, the Stepper Tiler Engine evicts the first pixel region from the cache. After the pixel regions in the cache have been processed, the processor can remove, or evict, the pixel regions from the cache. The pixel regions can continue to be stored in the memory storage.

The method 600 can be controlled by the Stepper Tiler Engine in a number of ways, including a protocol stream to and from the Stepper Tiler Engine over a communication bus, or through a shared memory and control registers (CSR) interface. Table 1 shows an embodiment of a CSR interface for performing the method 600.

| | Register | | | |
|---|---|---|---|---|
| Control Parameter | size | Read/Write | Meaning | Notes |
| ImageReadAddress | 64 bit | r/w | This is the address in system | |
| | | | memory where data is stored, which | |
| | | | points to the first line in the image | |
| ImageWriteAddress | 64 bit | r/w | This is the address in system | |
| | | | memory where data is written | |
| | | | from the evict buffer, such as for | |
| | | | in-place processing of data. | |
| | | | NOTE: writing the evict buffer is | |
| | | | optional, in some cases the evict | |
| | | | buffer is ignored and discarded. | |
| | | | See the EvictAndPrefetch parameter | |
| ImageLineSize | 16 bit | r/w | Size of each line | |
| imageLineCount | 16 bit | r/w | Total count of lines to read/write | |
| AreaXSize | 16 bit | r/w | Size of 2D rectangular area in pixels | |
| AreaYsize | 16 bit | r/w | Size of 2D rectangular area in pixels | |
| Active line buffer | 16 bit | r/w | Number of lines to be kept in the | |
| Prefetch line count | 16 bit | r/w | | |
| Evict line count | 16 bit | r/w | | |
| Line Step Interval | 16 bit | r/w | Number of lines to step | Allows for |
| | | | | arbitrary sized |
| | | | | intervals of lines |
| Start line offset | 16 bit | r/w | Line to start at in the memory buffer | Allows for |
| | | | | offsets into the |
| | | | | image buffer |
| Current line number | 16 bit | R | Current line at the top of the active | |
| Current line pointer | 64 bit | R | Pointer to current active line, top | |
| | | | of active buffer | |
| Current AreaVector | 16 bit | r/w | The array index of the active | This is assembled |
| index | | | rectangular area in the | automatically to |
| | | | CurrentAreaVector | speed up area |
| | | | | operations by |
| | | | | collapsing the area |
| | | | | into a sequential |
| | | | | 1D vector |
| Current AreaVector | 64 bit | R | Pointer to an 1D array containing | This is assembled |
| pointer | | | the rectangular area in the | automatically to |
| | | | CurrentAreaVector | speed up area |
| | | | | operations by |
| | | | | collapsing the area |
| | | | | into a sequential |
| | | | | 1D vector |
| Policy Controls | 16 bit | r/w | Structured bit vector type | |
| | | | 1 = polled CSR mode | |
| | | | 2 = interrupt on line end | |
| | | | 4 = interrupt on AreaVector end | |
| | | | 8 = Interrupt on error | |
| Start command | 16 bit | r/w | Start the StepperTiler: | This command |
| | | | 1 = start in line mode, load active area | initializes the |
| | | | 2 = start in area mode, load active area | active area lines, |
| | | | | including the |
| | | | | active lines and |
| Stop command | 16 bit | r/w | Stop the StepperTiler | |
| Status | 16 bit | r | Structured field: | |
| | | | 1 = running | |
| | | | 2 = stopped | |
| | | | 3 = error condition | |
| Evict Command | 16 bit | w | Structured field: | Uses Evict line count |
| | | | 1 = evict and discard | This is a |
| | | | 2 = evict and write-back (in-place | synchounous |
| | | | operation) | operation |
| Prefetch Command | 16 bit | w | Structured field: | Uses prefetch |
| | | | 1 = prefetch | line count |
| | | | 2 = prefetch and evict and discard | This is an |
| | | | 3 = prefetch and evict and writeback | asynchounous |
| | | | | operation, no |

The method 600 can be implemented using code written in C, C++, Java, MATLAB, FORTRAN, or any other programming language. The code can have a user set, among a number of parameters, the size and resolution of the image, the number of pixel regions, the size of the active buffer, the size of the eviction buffer, the size of the pre-fetch buffer, and the number of pixel regions to process at a time. The code can iteratively process each pixel or pixel region using an auto-increment command or algorithm. An example of the code illustrating the present techniques is shown below.

class StepperTiler
{

int64 *ImageReadAddress;
int64 *ImageWriteAddress;
int16 ImageLineSize;
int16 imageLineCount;
int16 AreaXSize;
int16 AreaYsize;
int16 ActiveLineBufferCount;
int16 PrefetchLineCount;
int16 EvictLineCount;
int16 LineStepInterval;
int16 StartLineOffset;
int16 CurrentLineNumber;
int64 *CurrentLinePointer;
int16 CurrentAreaVectorIndex;
int16 CurrentAreaVectorPointer;
int32 PolicyControls;
int32 StartCommand;
int32 StopCommand;
int32 Status;
int32 EvictCommand;
int32 PrefetchCommand;

};
enum
{

polledCSRmode,
interruptonlineend,
interruptonAreaVectorend,
Interruptonerror,
startinlinemode,
startinareamode,
stop,
running,
stopped,
errorcondition,
evictanddiscard,
evictandwriteback,
prefetch,
loadactiveareaandprefetch,
prefectchandwriteback,
prefectandevict

} COMMANDS;
int main( )
{

StepperTiler memory;
memory.ImageReadAddress = 0x1232300fffff;
memory.ImageWriteAddress = memory.ImageReadAddress;
// in place computation
// set up for 1080p
memory.ImageLineSize = 1920;
memory.imageLineCount = 1080;
// set up for 3×3 convolution
memory.AreaXSize = 3;
memory.AreaYsize = 3;
memory.ActiveLineBufferCount = 3;
memory.EvictLineCount = 1;
memory.PrefetchLineCount = 1;
memory.PolicyControls = evictandwriteback;
memory.LineStepInterval = 1;
memory.StartCommand = loadactiveareaandprefetch;
for (int x = 0; x < 1029; x++)
{

for (int y = 0; y < 1080; y++)
{
// convolve as a 1d vector multiple operation
convolve(&kernel, &memory.CurrentAreaVectorPointer[x]);
}
memory.EvictCommand = evictandwriteback; // synchronous
command
memory.PrefetchCommand = prefetch; //asynchonous command

}
}

The process flow diagram of FIG. 6 is not intended to indicate that the blocks of method 600 are to be executed in any particular order, or that all of the blocks are to be included in every case. Further, any number of additional blocks may be included within the method 600, depending on the details of the specific implementation.

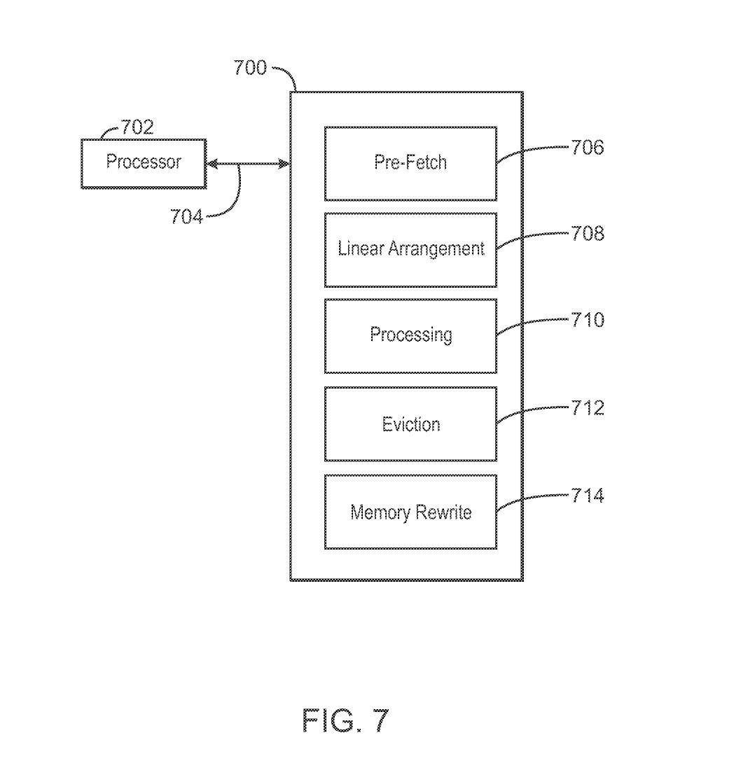

FIG. 7 is a block diagram showing tangible, non-transitory computer-readable media 600 that stores code for accessing an image in memory, in accordance with embodiments. The tangible, non-transitory, computer-readable media may be accessed by a processor 702 over a computer bus 704. Furthermore, the tangible, non-transitory computer-readable media 700 may include code configured to direct the processor 702 to perform the methods described herein.

The various software components discussed herein may be stored on the tangible, non-transitory computer-readable media 700, as indicated in FIG. 7. A pre-fetch module 706 may be configured to pre-fetch image data from a memory storage and place a pixel region into a cache. A linear arrangement module 708 may be configured to arrange the image data as a set of one-dimensional arrays so that the image data be can linearly processed. A processing block 710 may be configured to process the pixel region. An eviction block 712 may be configured to remove the pixel region from the cache. A memory rewrite block 704 may be configured to write the set of one-dimensional arrays back into memory storage.

The block diagram of FIG. 7 is not intended to indicate that the tangible, non-transitory computer-readable media 700 is to include all of the components shown in FIG. 7. Further, the tangible, non-transitory computer-readable media 700 may include any number of additional components not shown in FIG. 7, depending on the details of the specific implementation.

### Example 1

An apparatus for accessing an image in a memory is described herein. The apparatus includes logic to pre-fetch image data, wherein the image data comprises pixel regions and logic to arrange the image data as a set of one-dimensional arrays to be linearly processed. The apparatus also includes logic to process a first pixel region from the set of one-dimensional arrays, the first pixel region being stored in a cache, and logic to place a second pixel region from the set of one-dimensional arrays into the cache, wherein the second pixel region is to be processed after the first pixel region has been processed. Additionally, the apparatus includes logic to process the second pixel region, logic to write the processed pixel regions of the set of one-dimensional arrays back into the memory storage, and logic to evict the pixel regions from the cache.

The image data may be a line, region, block, or grouping of the image. The image data may be arranged using a set of pointers to the image data. At least one of the one-dimensional arrays is a linear sequence of pixel regions. The apparatus may also include logic to set the number of pixel regions to be processed in the cache simultaneously, logic to set the number of pixel regions to be placed into the cache prior to processing, or logic to set the number of pixel regions to be removed from the cache after processing. A line of pixel regions may be processed, or a rectangular block of pixel regions is processed. The pixel regions may be written to memory before the pixel regions are evicted from the cache. A pointer to the memory storage where pixel regions reside for read and write access may be set. The apparatus may be a printing device. The apparatus may also be an image capture mechanism. The image capture mechanism may include at least one or more sensors that gather image data.

### Example 2

A system for accessing an image in a memory storage is described herein. The system includes the memory storage to store image data, a cache and a processor. The processor may pre-fetch image data, wherein the image data includes pixel regions, arrange the image data as a set of one-dimensional array to be linearly processed, process a first pixel region from the image data, the first pixel region being stored in the cache, and place a second pixel region from the image data into the cache, wherein the second pixel region is to be processed after the first pixel region has been processed. The processor may also process the second pixel region, write the set of one-dimensional arrays back into the memory storage, and evict the first pixel region from the cache.

The image data may be arranged using a set of pointers to the image data. The system may include an output device communicatively coupled to the processor, the output device configured to display the image. The output device may be a printer, or the output device may be a display screen. The processor may process each pixel region in the image in a sequential order in accordance with the one-dimensional arrays. The image may be a frame of a video.

### Example 3

A tangible, non-transitory computer-readable media for accessing an image in a memory storage is described herein. The tangible, non-transitory computer-readable media includes instructions that, when executed by the processor, are configured to pre-fetch image data, wherein the image data comprises pixel regions, arrange the image data as a set of one-dimensional arrays to be linearly processed, and process a first pixel region from the image data, the first pixel region being stored in a cache. The instructions are also configured to place a second pixel region from the image data into the cache, wherein the second pixel region is to be processed after the first pixel region has been processed, process the second pixel region, write the set of one-dimensional arrays back into the memory storage, and evict the first pixel region from the cache.

The one-dimensional array may be a linear sequence of pixel regions. The image data may be arranged using a set of pointers to the image data. The number of pixel regions to be processed in the cache simultaneously may be set. Additionally, the number of pixel regions to be placed into the cache prior to processing. The number of pixel regions to be removed from the cache after processing may also be set A line of pixel regions may be processed, or a rectangular block of pixel regions may be processed.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus for accessing an image in a memory storage, comprising:
logic to pre-fetch image data, wherein the image data comprises pixel regions;
logic to arrange the image data as a set of one-dimensional arrays to be linearly processed;
logic to process a first pixel region from the set of one-dimensional arrays, the first pixel region being stored in a cache;
logic to place a second pixel region from the set of one-dimensional arrays into the cache, wherein the second pixel region is to be processed after the first pixel region has been processed;
logic to process the second pixel region;
logic to write the processed pixel regions of the set of one-dimensional arrays back into the memory storage; and
logic to evict the pixel regions from the cache.

2. The apparatus of claim 1, wherein the image data is a line, region, block, or grouping of the image.

3. The apparatus of claim 1, wherein the image data is arranged using a set of pointers to the image data.

4. The apparatus of claim 1, wherein at least one of the one-dimensional arrays is a linear sequence of pixel regions or a one dimensional array of pointers to pixels in the regions.

5. The apparatus of claim 1, further comprising logic to set the number of pixel regions to be processed in the cache simultaneously.

6. The apparatus of claim 1, further comprising logic to set the number of pixel regions to be placed into the cache prior to processing.

7. The apparatus of claim 1, further comprising logic to set the number of pixel regions to be removed from the cache after processing.

8. The apparatus of claim 1, wherein a line of pixel regions is processed.

9. The apparatus of claim 1, wherein the pixel regions are written to memory before the pixel regions are evicted from the cache.

10. The apparatus of claim 1, wherein a rectangular block of pixel regions is processed.

11. The apparatus of claim 1, further comprising logic to set a pointer to the memory storage where pixel regions reside for read and write access.

12. The apparatus of claim 1, wherein the apparatus is a printing device.

13. The apparatus of claim 1, wherein the apparatus is an image capture mechanism.

14. The apparatus of claim 13, wherein the image capture mechanism comprises one or more sensors that gather image data.

15. A system for accessing an image in a memory storage, comprising:
the memory storage to store image data;
a cache;
a processor to:
pre-fetch image data, wherein the image data comprises pixel regions;
arrange the image data as a set of one-dimensional array to be linearly processed;
process a first pixel region from the image data, the first pixel region being stored in the cache;
place a second pixel region from the image data into the cache, wherein the second pixel region is to be processed after the first pixel region has been processed;
process the second pixel region;
write the set of one-dimensional arrays back into the memory storage; and
evict the first pixel region from the cache.

16. The system of claim 15, wherein the image data is arranged using a set of pointers to the image data.

17. The system of claim 15, further comprising an output device communicatively coupled to the processor, the output device configured to display the image.

18. The system of claim 17, wherein the output device is a printer.

19. The system of claim 17, wherein the output device comprises a display screen.

20. The system of claim 15, the processor to process each pixel region in the image in a sequential order in accordance with the one-dimensional arrays.

21. The system of claim 15, wherein the image is a frame of a video.

22. A tangible, non-transitory computer-readable media for accessing an image in a memory storage, comprising instructions to:
pre-fetch image data, wherein the image data comprises pixel regions;
arrange the image data as a set of one-dimensional arrays to be linearly processed;
process a first pixel region from the image data, the first pixel region being stored in a cache;
place a second pixel region from the image data into the cache, wherein the second pixel region is to be processed after the first pixel region has been processed;
process the second pixel region;
write the set of one-dimensional arrays back into the memory storage; and
evict the first pixel region from the cache.

23. The tangible, non-transitory computer readable medium of claim 22, wherein the image data is arranged using a set of pointers to the image data.

24. The tangible, non-transitory computer-readable media of claim 22, wherein the one-dimensional array is a linear sequence of pixel regions.

25. The tangible, non-transitory computer-readable media of claim 22, further comprising instructions to set the number of pixel regions to be processed in the cache simultaneously.

26. The tangible, non-transitory computer-readable media of claim 22, further comprising instructions to set the number of pixel regions to be placed into the cache prior to processing.

27. The tangible, non-transitory computer-readable media of claim 22, further comprising instructions to set the number of pixel regions to be removed from the cache after processing.

28. The tangible, non-transitory computer-readable media of claim 22, wherein a line of pixel regions is processed.

29. The tangible, non-transitory computer-readable media of claim 22, wherein a rectangular block of pixel regions is processed.
